(19) United States
(12) Patent Application Publication
(10) Pub. No.: US 2025/0058720 A1
(43) Pub. Date: Feb. 20, 2025

(54) Multi-Purpose Vehicle

(71) Applicant: Kubota Corporation, Osaka-shi (JP)

(72) Inventor: Kazuyoshi Kawamoto, Sakai-shi (JP)

(21) Appl. No.: 18/805,634

(22) Filed: Aug. 15, 2024

(30) Foreign Application Priority Data
Aug. 18, 2023 (JP) 2023-133493

(51) Int. Cl. B60R 11/00

(52) U.S. Cl. CPC B60R 11/00; B60R 2011/004; B60R 2011/0052

(57) ABSTRACT

A multi-purpose vehicle includes a vehicle body having a travel device, and an attachment portion 31 that is provided on the vehicle body and to which a retrofittable optional item OP is removably attachable by a fastening member B. The attachment portion 31 includes a positioning mechanism 40 configured to position a cutting edge of a cutting tool for forming a hole through which the fastening member B is insertable.

### CROSS-REFERENCE TO RELATED APPLICATION

This application claims priority to Japanese Patent Application No. 2023-133493 filed Aug. 18, 2023, the disclosure of which is hereby incorporated by reference in its entirety.

### BACKGROUND OF THE INVENTION

### 1. Field of the Invention

The present invention relates to a multi-purpose vehicle.

### 2. Description of Related Art

As described in JP 2017-047796A, for example, a conventional multi-purpose vehicle is configured such that an optional item such as a work light is attachable thereto.

In such a multi-purpose vehicle, when an optional item is to be attached to the vehicle body using a fastening member such as a bolt, it is necessary to form a hole for inserting the fastening member. However, in a conventional multi-purpose vehicle, it is necessary to perform work to form a hole necessary for attaching an optional item, and forming a hole in the appropriate location is difficult for an unskilled worker who is not accustomed to such work.

### SUMMARY OF THE INVENTION

An object of the present invention is to provide a multi-purpose vehicle in which a hole for attaching an optional item can be easily formed.

A multi-purpose vehicle of the present invention includes: a vehicle body having a travel device; and an attachment portion that is provided on the vehicle body and to which a retrofittable optional item is removably attachable by a fastening member, in which the attachment portion includes a positioning mechanism configured to position a cutting edge of a cutting tool for forming a hole through which the fastening member is insertable.

According to this invention, by providing a positioning mechanism at a location suitable for attaching an optional item, the worker need only form a hole at the location positioned by the positioning mechanism, making it easy to form a hole for attaching the optional item.

In the present invention, it is preferable that the positioning mechanism is a conical recess in the attachment portion.

According to this configuration, while a worker is performing drilling work, the cutting edge of a cutting tool such as a drill can be easily aligned with the location where the hole is to be formed, whereby it is possible to stabilize the cutting edge, and it is possible to perform the drilling work easily. Also, by arranging the recess so as to match the position of an attachment hole formed in the optional item, the worker does not need to perform measurement of the attachment location or the like in advance, and therefore the drilling work is easier.

In the present invention, it is preferable that the positioning mechanism is a groove having a V-shaped cross section, the groove being in the attachment portion.

According to this configuration, the cutting edge of the cutting tool can be positioned by aligning the cutting edge with the groove having a V-shaped cross section. The worker can freely select the attachment location at the location where the groove is formed. Also, if the groove extends in the horizontal direction, the worker can more easily perform drilling work, such as easily forming a plurality of holes arranged side by side in the horizontal direction, by forming holes to align with the groove having a V-shaped cross section.

In the present invention, it is preferable that the positioning mechanism is a groove having a V-shaped cross section in the attachment portion and having a step at a position where the hole is formable through which the fastening member is insertable.

According to this configuration, it is possible to position the cutting edge of the cutting tool for forming the hole by using the step. Also, the worker can use the groove to form a hole even in a location without the step, if necessary. If the groove extends in the horizontal direction, the worker can easily perform drilling work, such as easily forming a plurality of holes arranged side by side in the horizontal direction, by forming holes to align with the groove having a V-shaped cross section.

In the present invention, it is preferable that the vehicle body has a resin part made of a resin member, and the attachment portion is provided in the resin part.

According to this configuration, the resin part includes the attachment portion and the positioning portion. In general, resin members are soft and easy to drill, and therefore the worker can easily perform the drilling work.

In the present invention, it is preferable that the vehicle body includes a cover covering at least a portion of a space in front of the travel device, and the attachment portion is provided in the cover.

According to this configuration, the cover covering the travel device includes the attachment portion and the positioning mechanism. In general, the cover covering the travel device has a complex shape, but the worker can easily perform drilling work on a cover of this type.

### BRIEF DESCRIPTION OF THE DRAWINGS

The terms Fig., Figs., Figure, and Figures are used interchangeably in the specification to refer to the corresponding figures in the drawings.

FIG. 1 is a side view of a multi-purpose vehicle.

FIG. 2 is a side view of a front cover.

FIG. 3 is a rear view showing a configuration of an attachment portion and a positioning mechanism.

FIG. 4 is a cross-sectional view taken along line IV in FIG. 3.

FIG. 5 is a diagram showing a configuration of a positioning mechanism according to another embodiment.

FIG. 6 is a diagram showing a configuration of a positioning mechanism according to another embodiment.

### DESCRIPTION OF THE INVENTION

Embodiments of the present invention will be described with reference to the drawings. Note that in the following description, unless otherwise specified, the direction of arrow FW in the drawings is “front”, the direction of arrow BK is “rear”, the direction of arrow LH is “left”, and the direction of arrow RH is “right”. The direction of arrow UP in the drawings is “up” and the direction of arrow DW is “down”.

### Overall Configuration

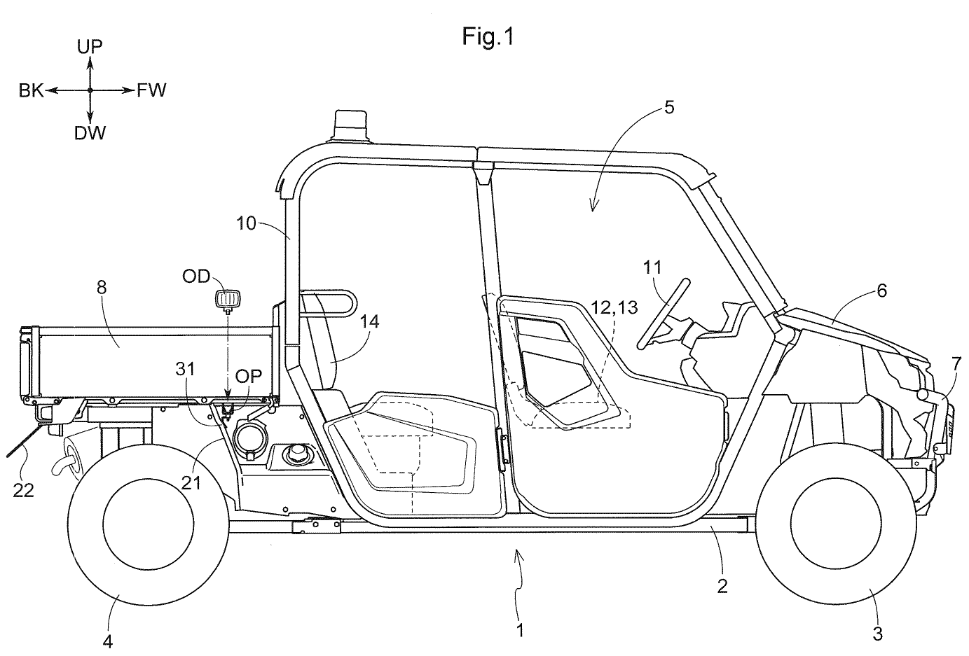

FIG. 1 shows a multi-purpose vehicle. The multi-purpose vehicle includes left and right body frames 2 that form a lower layer of a vehicle body 1. Left and right front wheels 3 (corresponding to travel devices) are supported on the front portions of the body frames 2, and left and right rear wheels 4 (corresponding to travel devices) are supported on the rear portions of the body frames 2. That is, the vehicle body 1 has front wheels 3 and rear wheels 4.

The vehicle body 1 includes a riding section 5 in which a passenger can ride, between the front wheels 3 and the rear wheels 4. A front lid 6 covering the upper parts of the front portions of the body frames 2 is provided at the front portion of the riding section 5. A front bumper 7 is provided at the front portion of the front lid 6. A truck bed 8 is provided rearward of the riding section 5.

Left and right edge portions of the truck bed 8 are located above the left and right rear wheels 4, respectively. A front cover 21 covering an upper portion in front of the rear wheels 4 and a rear cover 22 covering an upper portion behind the rear wheels 4 are respectively provided on the left and right sides below the truck bed 8 in the vehicle body 1. With this configuration, the front cover 21 and the rear cover 22 cover at least a portion in front of and behind the rear wheel 4.

### Riding Section

The riding section 5 includes a ROPS frame 10 that protects the passenger in the event that the vehicle body 1 falls over. The ROPS frame 10 is formed by bending a rod-shaped member, and spans from the front portion to the rear portion of the riding section 5.

The riding section 5 also includes a steering wheel 11 for steering the front wheels 3, and a driver's seat 12 in which an occupant operating the steering wheel 11 can sit. The driver's seat 12 is arranged at the front portion of the riding section 5. An auxiliary passenger seat 13 in which an occupant can sit is provided to the right of the driver's seat 12 in the riding section 5 and is arranged side by side with the driver's seat 12. Furthermore, a rear passenger seat 14 in which an occupant can sit is provided behind the driver's seat 12 and the auxiliary passenger seat 13.

### Attachment of Optional Device and Optional Member

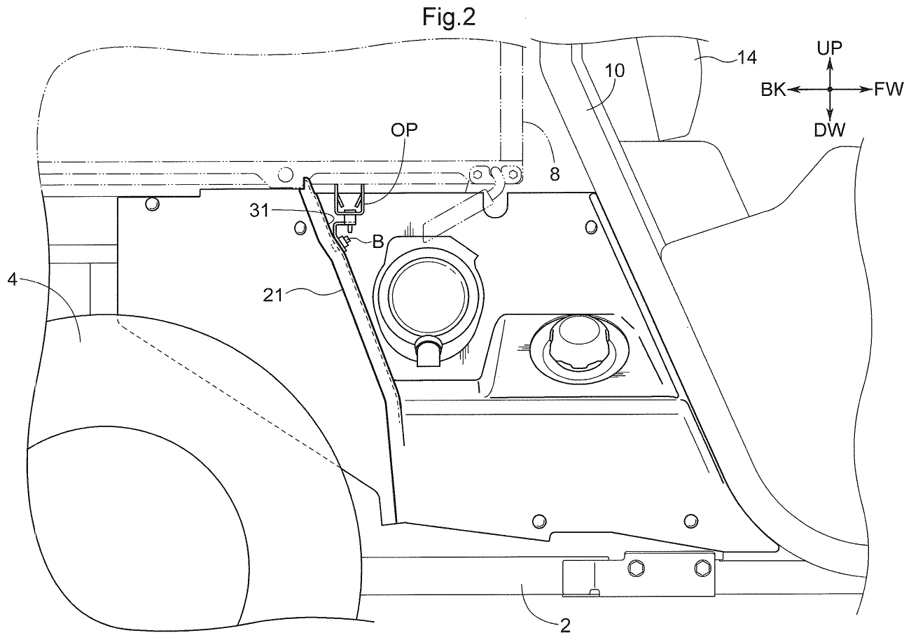

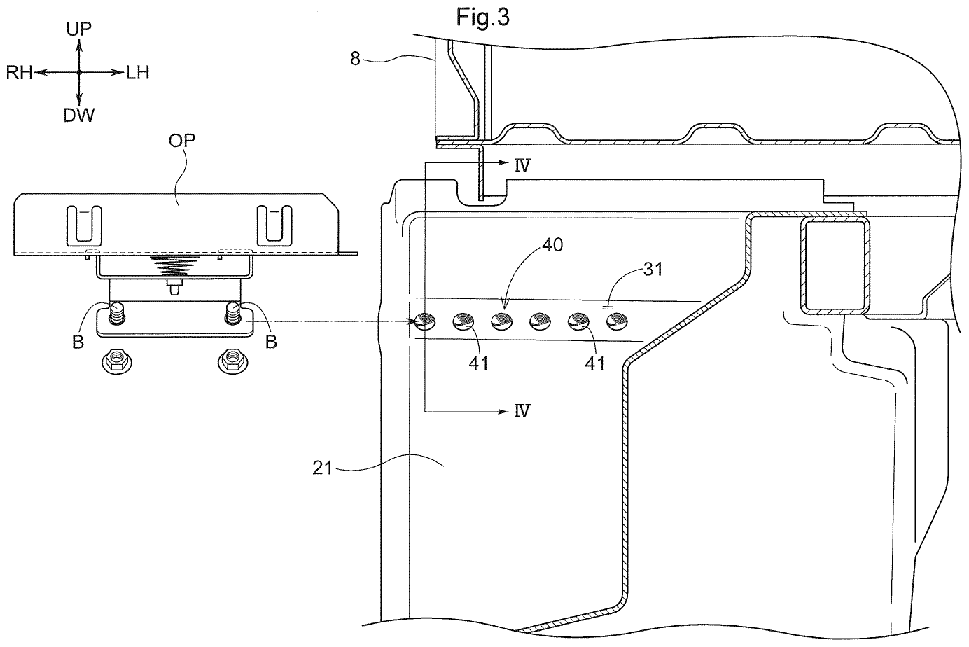

The front cover 21 of this embodiment includes an attachment portion 31 to which an optional device OD (see FIG. 3) such as a work light or decorative lighting, which is an optional item, and an optional member OP such as a stay for supporting a harness for the optional device OD is retrofittable, as shown in FIGS. 1 and 2. The optional device OD and the optional member OP are removably attached to the attachment portion 31 by bolts B, which are fastening members.

The front cover 21 of this embodiment is a resin part made of a resin member. That is, the attachment portion 31 is provided in a resin part.

The attachment portion 31 includes a positioning mechanism 40 for positioning a cutting edge of a cutting tool for forming holes through which the bolts B are to be inserted, as shown in FIG. 3. The positioning mechanism 40 of this embodiment is a recess 41 formed in the attachment portion 31, and the attachment portion 31 has a plurality of recesses 41.

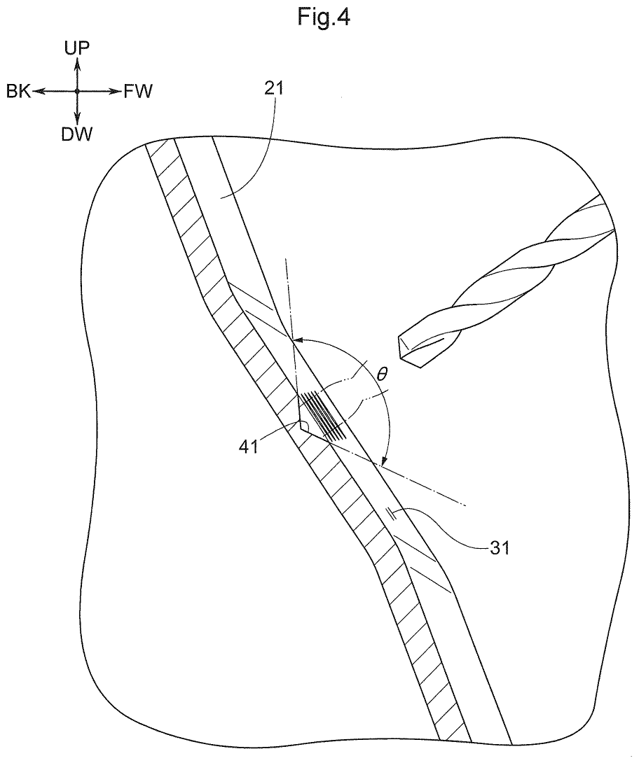

The recesses 41 of this embodiment are each formed in a conical shape. An apex angle θ of the conical shape shown in FIG. 4 is not particularly limited, but is preferably 120 degrees, which is the same as the angle (apex angle) of the cutting edge of a drill or the like, which is a common cutting tool.

### Attachment Work

Work for attaching the optional device OD and the optional member OP to the attachment portion 31 will be described below.

The worker selects, from the plurality of recesses 41 shown in FIG. 3, a recess 41 at a position suitable for attaching the optional device OD and the optional member OP, which are the objects to be attached.

Next, the worker places the cutting edge of a cutting tool such as a drill against the selected recess 41 and rotates the cutting edge to perform drilling work. Since the cutting edge is inserted into the recess 41 at this time, it is possible to reduce the inconvenience of the cutting edge being misaligned during rotation.

The worker can attach the optional member OP, which is the object to be attached, to the attachment portion 31 by inserting a bolt B, which is a fastening member, through the formed hole after completing the drilling work for all of the selected recesses 41.

### Alternative Embodiments

Hereinafter, alternative embodiments obtained by modifying the above-described embodiment will be described.

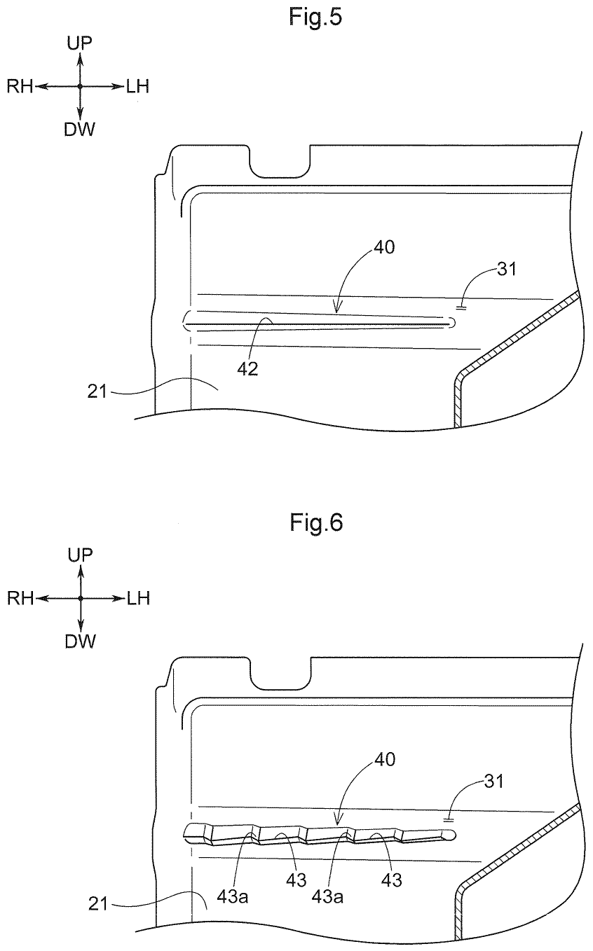

(1) In the above-described embodiment, a configuration was described as an example in which the plurality of recesses 41 are formed as the positioning mechanism 40. However, the present invention is not limited to the above-described embodiment. For example, a groove 42 having a V-shaped cross section may be formed in the attachment portion 31 as the positioning mechanism 40, as shown in FIG. 5. With this configuration, the cutting edge of the cutting tool can be positioned by aligning the cutting edge with the groove 42 having a V-shaped cross section. Also, the degree of freedom in attaching optional items can be increased since the attachment location can be freely selected in the extension direction of the groove 42.

As shown in FIG. 6, the positioning mechanism 40 may be grooves 43 having V-shaped cross sections in the attachment portion 31 and having steps 43a provided at positions where holes are to be formed through which the bolts B, which are fastening members, are to be inserted. This configuration allows a higher degree of freedom in attaching the optional device OD and the optional member OP in the extension direction of the groove 43, and makes it possible to position the cutting edge of a cutting tool for forming a hole by using the steps 43a.

(2) In the above-described embodiment, a configuration was described as an example in which the front cover 21 and the attachment portion 31 are provided on a resin part made of a resin member. However, the present invention is not limited to the above-described embodiment, and may be made of, for example, a metal member or a wooden member.

(3) In the above-described embodiment, a configuration was described as an example in which the attachment portion 31 is provided on the front cover 21.

However, the present invention is not limited to the above-described embodiment, and for example, the attachment portion 31 may be provided on the rear cover 22, or the attachment portion 31 may be provided on the truck bed 8.

Note that the configurations disclosed in the above-described embodiment (including alternative embodiments, the same applies below) can be applied in combination with configurations disclosed in alternative embodiments, unless a contradiction occurs. The embodiments disclosed in this specification are merely examples, and the embodiments of the present invention are not limited thereto, and can be modified as appropriate without departing from the object of the present invention.

### INDUSTRIAL APPLICABILITY

The present invention can be applied to a multi-purpose vehicle used for transporting people, carrying luggage, recreation, and the like.

### REFERENCE SIGNS LIST

1 Vehicle body
3 Front wheel (travel device)
4 Rear wheel (travel device)
31 Attachment portion
40 Positioning mechanism
41 Recess
42 Groove
43 Groove
43a Step
B Fastening member (bolt)
OD Optional device (optional item)
OP Optional member (optional item)

What is claimed is:

1. A multi-purpose vehicle comprising:
a vehicle body comprising a travel device; and
an attachment portion that is provided on the vehicle body and to which a retrofittable optional item is removably attachable by a fastening member, and
wherein the attachment portion comprises a positioning mechanism configured to position a cutting edge of a cutting tool for forming a hole through which the fastening member is insertable.

2. The multi-purpose vehicle according to claim 1,
wherein the positioning mechanism is a conical recess in the attachment portion.

3. The multi-purpose vehicle according to claim 1,
wherein the positioning mechanism is a groove having a V-shaped cross section, and
wherein the groove is in the attachment portion.

4. The multi-purpose vehicle according to claim 1,
wherein the positioning mechanism is a groove having a V-shaped cross section in the attachment portion and having a step at a position where the hole is formable through which the fastening member is insertable.

5. The multi-purpose vehicle according to claim 1,
wherein the vehicle body has a resin part made of a resin member, and
wherein the attachment portion is provided in the resin part.

6. The multi-purpose vehicle according to claim 1,
wherein the vehicle body comprises a cover covering at least a portion in front of the travel device, and
wherein the attachment portion is provided in the cover.
